(19) United States
(12) Patent Application Publication
(10) Pub. No.: US 2025/0263531 A1
(43) Pub. Date: Aug. 21, 2025

(54) METHODS OF PRODUCING EMBOSSED CROSSLINKED POLYOLEFIN FOAMS

(71) Applicant: Toray Plastics (America), Inc., North Kingstown, RI (US)

(72) Inventors: Dan BEN-DAAT, Winchester, VA (US); Tyler Austin BOWMAN, Stephenson, VA (US)

(73) Assignee: Toray Plastics (America), Inc., North Kingstown, RI (US)

(21) Appl. No.: 18/582,298

(22) Filed: Feb. 20, 2024

(51) Int. Cl. C08J 9/228; C08J 9/06; C08J 9/224

(52) U.S. Cl. CPC C08J 9/228; C08J 9/06; C08J 9/224; C08J 2207/00; C08J 2323/06; C08J 2323/12

(57) ABSTRACT

Described herein are physically crosslinked polyolefin, embossed closed cell continuous foam structures. The embossing can be performed during the extrusion step such that at least one surface of an extruded foamable sheet can be embossed with a pattern before the irradiation and foaming of the foamable sheet.

### FIELD OF THE DISCLOSURE

This disclosure relates generally to crosslinked polyolefin embossed foam structures, and more specifically, to crosslinked polyolefin embossed foam structures, wherein embossing is performed on the unfoamed extruded foam sheet.

### BACKGROUND OF THE DISCLOSURE

Crosslinked polyolefin foam sheets are used in numerous applications and produced by a variety of methods. In one method, crosslinked polyolefin foam sheets are obtained by (a) extruding a foamable composition, (b) irradiating the foamable composition with ionizing radiation, and then (c) continuously foaming the composition.

In some applications, it can be desirable for at least one surface of the foam sheet to be embossed. For example, an embossed surface can modify the slip characteristics of the foam sheet when in contact with another surface and/or be more visually and/or more tactilely desirable when compared to a non-embossed foam surface.

Embossing of commercially produced crosslinked polyolefin foam sheets is traditionally accomplished as a secondary operation on equipment specifically designed for embossing sheet rolls of foams and/or films. For example, a typical embossing process can involve taking previously manufactured polyolefin foam rolls, unwinding the rolls, heating the surface (or surfaces) to be embossed to a temperature appropriate for embossing, contacting the heated surface(s) onto an engraved roll under pressure or vacuum to impart the engraved pattern onto the foam surface(s), and then cooling the surface(s) prior to rewinding the foam sheet. As such, traditional embossing of the foamed sheet is a fourth step (d) in the production method after foaming, commonly referred to as post-embossing.

### SUMMARY OF THE DISCLOSURE

It has been discovered that it is possible to produce a physically crosslinked polyolefin, embossed closed cell continuous foam sheet by incorporating the embossing step into the extrusion step of the foam production process. Specifically, an embossed foam sheet can be produced by extruding a foamable composition through a nip where at least one of the nip rolls is engraved with an embossing pattern. The embossed, extruded unfoamed or foamable sheet can be irradiated with ionizing radiation and the irradiated sheet can then be foamed. By incorporating the embossing step into the extrusion of the foamable composition, the number of manufacturing steps can be reduced, thereby eliminating post-embossing operations, simplifying the production of the foam, and/or reducing costs associated with the manufacturing of the foam.

In some embodiments, a method of forming an embossed polyolefin foam includes extruding a foamable sheet comprising polypropylene and/or polyethylene; embedding a pattern on at least one side of the extruded foamable sheet; irradiating the embedded foamable sheet with ionizing radiation; and foaming the irradiated foamable sheet. In some embodiments, embedding the pattern on the at least one side of the extruded foamable sheet comprises applying pressure to both sides of the extruded foamable sheet via a plurality of rollers. In some embodiments, the plurality of rollers comprises at least one roller comprising the pattern. In some embodiments, the pattern is engraved on the at least one roller. In some embodiments, the method includes embedding a second pattern on a side of the extruded foamable sheet opposite the side of the extruded foamable sheet with the embedded first pattern. In some embodiments, the pattern comprises depressions in the at least one side of the extruded foamable sheet. In some embodiments, the pattern comprises a text pattern. In some embodiments, the embedded pattern comprises depressions on the at least one side of the extruded foamable sheet and the depressions are 5-75% of an overall thickness of the embedded foamable sheet. In some embodiments, the foamable sheet comprises a chemical foaming agent. In some embodiments, the ionizing radiation is selected from the group consisting of alpha, beta (electron), x-ray, gamma, and neutron. In some embodiments, the embedded foamable sheet is irradiated up to four separate times. In some embodiments, the ionizing radiation crosslinks the embedded foamable sheet to a crosslinking degree of 20-75%. In some embodiments, foaming comprises heating the irradiated foamable sheet with molten salt and radiant heaters or a hot air oven. In some embodiments, the method includes applying a laminate layer to a side of the foamed sheet opposite the side of the foamed sheet with the embedded pattern. In some embodiments, the laminate layer comprises a solid hardwood floor panel, an engineered wood floor panel, a laminate floor panel, a vinyl floor tile, a ceramic floor tile, a porcelain floor tile, a stone floor tile, a quartz floor tile, a cement floor tile, or a concrete floor tile. In some embodiments, the method includes applying a pressure sensitive adhesive layer to a side of the foamed sheet opposite the side of the foamed sheet with the embedded first pattern prior to applying the laminate layer to the side of the foamed sheet opposite the side of the foamed sheet with the embedded pattern. In some embodiments, the method includes applying a pressure sensitive adhesive layer to a side of the laminate layer prior to applying the laminate layer to the side of the foamed sheet opposite the side of the foamed sheet with the embedded pattern.

In some embodiments, a flooring system includes a top floor layer; an underlayment layer comprising an embossed polyolefin foam disclosed herein, wherein the one or more underlayment layers are on a side of the top floor layer; and a sub-floor layer on a side of the underlayment layer opposite the top floor layer. In some embodiments, the top floor layer is attached to the underlayment layer and the sub-floor layer is attached to the underlayment layer via an adhesive. In some embodiments, the adhesive comprises a urethane adhesive and/or an acrylic adhesive.

As used herein, the singular forms “a,” “an,” and “the” are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

It is understood that aspects and embodiments described herein include “consisting” and/or “consisting essentially of” aspects and embodiments. For all methods, systems, compositions, and devices described herein, the methods, systems, compositions, and devices can either comprise the listed components or steps, or can “consist of” or “consist essentially of” the listed components or steps. When a system, composition, or device is described as “consisting essentially of” the listed components, the system, composition, or device contains the components listed, and may contain other components which do not substantially affect the performance of the system, composition, or device, but either do not contain any other components which substantially affect the performance of the system, composition, or device other than those components expressly listed; or do not contain a sufficient concentration or amount of the extra components to substantially affect the performance of the system, composition, or device. When a method is described as “consisting essentially of” the listed steps, the method contains the steps listed, and may contain other steps that do not substantially affect the outcome of the method, but the method does not contain any other steps which substantially affect the outcome of the method other than those steps expressly listed.

In the disclosure, “substantially free of” a specific component, a specific composition, a specific compound, or a specific ingredient in various embodiments, is meant that less than about 5%, less than about 2%, less than about 1%, less than about 0.5%, less than about 0.1%, less than about 0.05%, less than about 0.025%, or less than about 0.01% of the specific component, the specific composition, the specific compound, or the specific ingredient is present by weight. Preferably, “substantially free of” a specific component, a specific composition, a specific compound, or a specific ingredient indicates that less than about 1% of the specific component, the specific composition, the specific compound, or the specific ingredient is present by weight.

Additional advantages will be readily apparent to those skilled in the art from the following detailed description. The examples and descriptions herein are to be regarded as illustrative in nature and not restrictive.

### BRIEF DESCRIPTION OF THE DRAWINGS

FIG. 1 illustrates an exemplary typical foam sheet embossing process in accordance with some embodiments disclosed herein.

FIG. 2 illustrates an exemplary foam sheet embossing process in accordance with some embodiments disclosed herein.

FIG. 3 illustrates an image of an embossing nip with three rollers and a middle embossing roller in accordance with some embodiments disclosed herein.

FIG. 4 illustrates an example of a cross section of an embossed unfoamed sheet and the corresponding cross section of the embossed foamed sheet in accordance with some embodiments disclosed herein.

FIG. 5 illustrates an example of a top view of an embossed unfoamed sheet and the corresponding top view of the embossed foamed sheet in accordance with some embodiments disclosed herein.

FIG. 6 illustrates an example of an embossed unfoamed sheet and the corresponding zoomed in view of the embossed foamed sheet in accordance with some embodiments disclosed herein.

In the Figures, like reference numerals refer to like components unless otherwise stated herein.

### DETAILED DESCRIPTION OF EXEMPLARY EMBODIMENTS

Described are foam structures and methods of producing crosslinked, embossed closed cell continuous polyolefin foam structures (e.g., films, layers, sheets, etc.) by incorporating the embossing during extrusion of the foamable composition. In some embodiments, the polyolefin foam structure can be obtained by (a) extruding a foamable composition through a nip where at least one of the nip rolls has an embossing pattern, (b) irradiating the embossed, extruded foamable sheet with ionizing radiation, and (c) foaming the extruded, irradiated foamable sheet.

In the extrusion step, raw materials of the foamable composition can be fed into an extruder. The method of feeding ingredients into the extruder can be based on the design of the extruder and the material handling equipment available. Preblending ingredients of the foamable composition may be performed, if necessary or desired, to facilitate their dispersal. If performed, a Henshel mixer may be used for preblending. In some embodiments, all ingredients can be preblended and fed thru a single port in the extruder. In some embodiments, the ingredients can also be individually fed thru separate designated ports for each ingredient or into a single port in the extruder. For example, if an ingredient is a liquid, the liquid can be added through a feeding gate (or gates) on the extruder or through a vent opening on the extruder (if equipped with a vent) instead of being preblended with solid ingredients. Combinations of preblending and individual ingredient port feeding can also be employed. Exemplary extrusion techniques are also disclosed in Chapter 8 of Handbook of Polymeric Foam and Foam Technology (2nd Edition, edited by Daniel Klempner and Vahid Sendijarevic), the subject matter of which is incorporated herein by reference in its entirety.

In some embodiments, the extruder can deliver a steady amount of a foamable composition into a sheeting die to create an unfoamed or foamable sheet. The thickness of the unfoamed sheet can be controlled by the overall die gap. However, the sheet thickness can further be adjusted, for example, by stretching (i.e., “drawing”) the melted extrudate and/or flattening the melted extrudate through an embossing nip. It is to be understood that the term foam structure as used herein incorporates various foam structures including but not limited to foam sheets, films, layers, etc.

A foamable composition fed into the extruder can include at least one polypropylene and/or at least one polyethylene. Since a broad range of foam articles can be created with the disclosed foamable composition, a broad range of polypropylenes and/or polyethylenes can be employed in the composition to meet various in-process manufacturing requirements and commercial end use requirements.

In some embodiments, polypropylene includes, but is not limited to, a broad range of homopolymer polypropylene (“hPP”), polypropylene-ethylene copolymer, and/or polypropylene based thermoplastics polyolefin (“TPO”), which can be employed in the foamable composition to meet various in-process manufacturing requirements and commercial end use requirements.

A non-limiting example of hPP can be an isotactic homopolypropylene. Commercially available examples can include, but are not limited to, FF018F from Braskem, 3271 from Total Petrochemicals, and COPYLENE™ CH020 from Phillips 66.

In some embodiments, polypropylene-ethylene copolymer can be polypropylene with random ethylene units. A few non-limiting examples of commercially available “polypropylene-ethylene copolymer” are 6232, 7250FL, and Z9421 from Total Petrochemicals, 6D20 and DS6D81 from Braskem, and PRO-FAX® RP311H and ADSYL® 7415XCP from LyondellBasell.

In some embodiments, polypropylene based thermoplastic polyolefin (“TPO”) can be hPP or polypropylene-ethylene copolymer which also have ethylene-propylene copolymer rubber in amounts great enough to give the TPO plastomeric, elastoplastomeric, and/or elastomeric properties. Non-limiting examples of TPO polymers can include those polymers commercially available under the trade names THERMORUN® and ZELAS® from Mitsubishi Chemical Corporation, ADFLEX® and SOFTELL® from LyondellBasell, TELCAR® from Teknor Apex Company, and WELNEX™ from Japan Polypropylene Company. TPO can be produced via multi-stage polymerization (for example, ZELAS®, ADFLEX®, SOFTELL®, and WELNEX®) or by blending (for example, THERMORUN® and TELCAR®).

In some embodiments, polyethylene includes, but is not limited to, a broad range of low density, linear low density, and olefin block copolymer (OBC) polyethylenes which can be employed in the composition to meet various in-process manufacturing requirements and commercial end use requirements.

“LDPE” is low density polyethylene homopolymer commonly produced in high pressure tubular and autoclave reactors. In the reaction, gaseous ethylene monomer is polymerized under very high pressures and high temperatures in the presence of oxide initiators to produce a polymer structure with long and short branches. LDPE is one of the most widely commercially produced commodity thermoplastic worldwide and manufactured by both by large multinational corporations (Dow, ExxonMobil, LyondellBasell, Sinopec, PetroChina, SABIC, Borealis, etc.) and mid-to-smaller companies (Westlake, Nova, Japan Polyethylene, Repsol, PKN Orlen, Carmel, etc.) Non-limiting examples of commercial LDPE grades are marketed under various tradenames. For example, the LDPE manufacturers listed above sell commercial grades under the tradenames Dow™ LDPE (Dow), ExxonMobil™ LDPE (ExxonMobil), SINOPEC LDPE, (Sinopec), SABIC® LDPE, Borealis LDPE, Westlake Polyethylene™ (Westlake), NOVAPOL® (Nova), NOVATEC®-LD (Japan Polyethylene), Repsol Alcudia and Repsol PE Ultraclean® (Repsol), Malen (PKN Orlen), and Ipethene® (Carmel).

“LLDPE” is linear low density polyethylene commonly produced in low pressure fluidized bed reactors at significantly lower temperatures than LDPE. In the reaction, gaseous ethylene monomer (and very commonly additional α-olefin comonomers) is/are polymerized by multi-site transition metal Ziegler-Natta type catalysts to produce a substantially linear polymer structure with branching that, compared to LDPE, exhibits significantly more but shorter branches. Long chain branching is absent in LLDPE.

LLDPE can be a polyethylene homopolymer but is more commonly produced commercially as a random copolymer or random terpolymer. Most commercial LLDPE is copolymerized with at least one C3-C20 α-olefin of which 1-butene, 1-hexene, and 1-octene are the most typical.

Many producers of LDPE polymer also manufacture LLDPE polymer. Non-limiting examples of commercial LLDPE grades from the LDPE manufacturers listed above are marketed and sold under the tradenames Dow™ LLDPE and Dowlex™ (Dow), ExxonMobil™ LLDPE and ExxonMobil™ NTX LLDPE (ExxonMobil), SINOPEC LLDPE (Sinopec), SABIC® LLDPE (Sabic), Borealis LLDPE and Borstar® (Borealis), HIFOR® and HIFOR Xtreme® (Westlake), NOVAPOL® and SCLAIR® and SURPASS® (Nova), and NOVATEC®-LL (Japan Polyethylene).

“Polyethylene-based OBC” (also referred to herein as OBC) is a multi-block LLDPE copolymer containing harder crystallizable LLDPE copolymer “blocks” alternating with amorphous softer LLDPE copolymer “blocks” that are not randomly distributed—that is, in a controlled (non-random) block sequence. The softer block comprises a higher amount of comonomer (most common are C3-C20 α-olefin) than the harder block. OBC is produced in a reactor by tandem catalysis using two “post-metallocene” (non-metallocene single-site and/or non-metallocene single-site capable) catalysts-one for polymerization of each block. Polymer synthesis occurs by transferring the polymer chain from one catalyst to the other (and vice-versa) and is referred to as “chain shuttling copolymerization”. An example of OBC includes, but is not limited to, the INFUSE™ OBC product line from Dow. In the commercially produced INFUSE™ OBC product line, the copolymer is 1-octene in both the harder and softer blocks.

In some embodiments, monomers used to produce the polypropylene(s) and/or polyethylene(s) can be petroleum and/or bio-based (i.e., plant based) and can be sourced as virgin material and/or sourced from a recycling method such as chemical or pyrolytic recycling. In some embodiments, the polypropylene(s) and/or polyethylene(s) can also be recycled polymers. In some embodiments, the recycled polymers can be “PCR” type (post-consumer recycled/post-consumer resin) and/or “PIR” type (post-industrial recycled/post-industrial resin).

In some embodiments, the foamable compositions of the extrudable foamable sheet can have at least one polypropylene having a melt flow index from about 0.1 to about 25 grams per 10 minutes at 230° C. In some embodiments, the composition of the extruded foamable sheet can also contain at least one polyethylene having a melt flow index from about 0.1 to about 25 grams per 10 minutes at 190° C. In some embodiments, the melt flow index of the polypropylene(s) and/or polyethylene(s) can be about 0.3 to about 20 grams per 10 minutes at 230° C. and at 190° C., respectively, or about 0.5 to about 15 grams per 10 minutes at 230° C. and at 190° C., respectively. The “melt flow index” (MFI) value for a polymer provided herein can be defined and measured according to ASTM D1238 at 230° C. for polypropylenes and at 190° C. for polyethylenes using a 2.16 kg plunger for 10 minutes. The test time may be reduced for relatively high melt flow resins.

The MFI can provide a measure of flow characteristics of a polymer and is an indication of the molecular weight and processability of a polymer material. High MFI values correspond to low viscosities. If the MFI values are too high, extrusion according to the present disclosure may not be satisfactorily carried out. Problems associated with MFI values that are too high can include low pressures during extrusion, problems setting the thickness profile, uneven cooling profile due to low melt viscosity, poor melt strength, and/or machine problems. Conversely, low MFI values can correspond to high viscosities. MFI values that are too low can cause high pressures during melt processing, sheet quality and profile problems, and higher extrusion temperatures which cause a risk of chemical foaming agent decomposition and activation.

The above MFI ranges may be important for foaming processes because they can reflect the viscosity of the material, which has an effect on the foaming. Without being bound by any theory, it is believed there are several reasons why particular MFI values may be more effective. A lower MFI material may improve some physical properties as the molecular chain length is greater, creating more energy needed for chains to flow when a stress is applied. Also, the longer the molecular chain (MW), the more crystal entities the chain can crystallize, thus providing more strength through intermolecular ties. However, at too low an MFI, the viscosity can become too high. On the other hand, polymers with higher MFI values can have shorter chains. Therefore, in a given volume of a material with higher MFI values, there may be more chain ends on a microscopic level relative to polymers having a lower MFI, which can rotate and create free volume due to the space needed for such rotation (e.g., rotation occurring above the Tg, or glass transition temperature of the polymer). This can increase the free volume and enable an easy flow under stress forces which may cause cell degradation and “foam collapse” of the foamed polymer blend.

In addition to the polymers, the compositions fed into the extruders may also contain additives compatible with producing the disclosed polyolefin foams. Common additives include, but are not limited to, chemical foaming agents (CFA), crosslinking promoters, organic peroxides, antioxidants, lubricants, processing aids, thermal stabilizers, colorants, flame retardants, antistatic agents, electrostatic dissipative agents, nucleating agents, plasticizers, antimicrobials, fungicides, light stabilizers, UV absorbents, anti-blocking agents, fillers, deodorizers, odor adsorbers, anti-fogging agents, volatile organic compound (VOC) adsorbers, semi-volatile organic compound (SVOC) adsorbers, thickeners, cell size stabilizers, metal deactivators, chemical foaming agent (CFA) decomposition accelerants, chemical foaming agent (CFA) suppressants, optical clarifiers, and combinations thereof.

In some embodiments, the foamable composition can contain a chemical foaming agent (CFA). In some embodiments, the extrusion temperature for the foamable composition can be at least 10° C. below the thermal decomposition initiation temperature of the chemical foaming agent. If the extrusion temperature exceeds the thermal decomposition temperature of the foaming agent, then the foaming agent may decompose, resulting in undesirable “prefoaming.”

In some embodiments, the foamable composition can include a variety of different chemical foaming agents and can include exothermic and endothermic types. Examples of chemical foaming agents include, but are not limited to, azo compounds, hydrazine compounds, carbazides, tetrazoles, nitroso compounds, and carbonates. In addition, a chemical foaming agent may be employed alone or in any combination. One chemical foaming agent that can be used in some embodiments is azodicarbonamide (ADCA). Two examples of commercially produced ADCA chemical foaming agents are UNIFOAM™ TC-18I (100% ADCA) made by P.T. Lauten Otsuka Chemical and VINYFOR™ AC-961 (≥90% ADCA) made by EIWA Chemical. ADCA's thermal decomposition typically occurs at temperatures between about 190 to 230° C. In some embodiments, in order to prevent ADCA from thermally decomposing in the extruder, extruding temperature can be maintained at or below 190° C.

In some embodiments, the amount of chemical foaming agent can depend on the unfoamed or foamable sheet thickness, desired foam thickness, desired foam density, materials being extruded, crosslinking percentage, type of chemical foaming agent (different foaming agents can generate significantly different quantities of gas), among others, or combinations thereof. For example, when comparing ADCA to the chemical foaming agent p-toluenesulfonyl semicarbazide (“TSS”), if a foamable sheet contains 40 PHR ADCA, then about 63 PHR TSS would be required to generate about the same amount gas during the foaming step.

Regardless of how ingredients of the foamable composition are fed into the extruder, the shearing force and mixing within an extruder can be sufficient to produce a homogenous sheet (otherwise referred to herein as a layer, film, structure, etc.). Co-rotating and counter-rotating twin screw extruders can provide sufficient shearing force and mixing thru the extruder barrel to extrude a sheet with uniform properties.

Specific energy can be an indicator of how much work is being applied during the extrusion of the ingredients and how intensive the extrusion process is. Specific energy is defined as the energy applied to a material being processed by the extruder, normalized to a per kilogram basis. The specific energy can be quantified in units of kilowatts of applied energy per total material fed in kilograms per hour. Specific energy can be calculated according to the formula:

$$Specific Energy = \frac{KW ( applied )}{feedrate ( \frac{kg}{hr} )} , where$$

$$KW ( applied ) = \frac{\begin{matrix}KW ( motor rating ) * ( \% torque from maximum allowable in decimal form ) * \\ RPM ( actual running RPM ) * 0.97 ( gearbox efficiency )\end{matrix}}{Max RPM ( capability of extruder )}$$

Specific energy can be used to quantify the amount of shearing and mixing of the ingredients within the extruder. Extruders used to form the foamable sheets disclosed herein can be capable of producing a specific energy of at least about 0.020 kW·hr/kg, at least about 0.025 kW·hr/kg, at least about 0.050 kW·hr/kg, or at least about 0.100 kW·hr/kg.

If the difference between the decomposition temperature of the thermally decomposable foaming agent and the melting point of the polymer with the highest melting point is high, then a catalyst for foaming agent decomposition may be used. Exemplary catalysts include, but are not limited to, zinc oxide, magnesium oxide, calcium stearate, glycerin, and urea. The lower temperature limit for extrusion can be that of the polymer with the highest melting point. If the extrusion temperature drops below the melting temperature of the polymer with the highest melting point, then undesirable “unmelts” may appear. Upon foaming, the sheet that was extruded below this lower temperature limit can exhibit uneven thickness, a non-uniform cell structure, pockets of cell collapse, and/or other undesirable attributes.

Regardless of whether the foaming agents are physical, chemical, or a combination, typical extrusion foaming can generate polymer sheets (e.g., layers, films, structures) where both primary surfaces may be significantly rougher than equivalent structures produced in the disclosed method. The surface profile of a foamable or foamed sheets can be important in many applications and thus extrusion foamed sheets may not be used for these applications. These applications can include a smooth foam surface to obtain desired properties such as improving the percentage contact area when a pressure sensitive adhesive (PSA) is applied onto the foam surface; ease of lamination to a film, fabric, fiber layer, and a leather; percentage contact area in the lamination; and/or visual aesthetics; etc. PCT Publication WO 2016109544, which is hereby incorporated in its entirety by reference, includes examples illustrating the difference in surface roughness between extrusion foamed polymer sheets and equivalent foamed polymer sheets produced by the disclosed method.

The rougher surfaces of extrusion foamed articles can be generally caused by larger sized cells (when compared to the foams produced according to the present disclosure). Although the cell size and cell size distribution may not matter in many commercial applications, because surface roughness is a function of cell size, foams with larger cells can be less desirable than foams with smaller cells for applications requiring a smooth foam surface.

In some embodiments, the thickness of the unfoamed or foamable extruded sheet can be about 0.1 to about 30 mm and an embossed pattern on the unfoamed extruded sheet can be from about 5-75% of the overall sheet thickness. In some embodiments, the embossed pattern depth (or thickness) can be determined by the depth of the engraving on the embossing roll, the applied nip pressure, and/or the melt properties of the extruded foamable composition.

There is a difference between the terms “debossing” and “embossing.” Debossing and embossing can use similar or the same techniques to impart a pattern onto a surface. Debossing is when a pattern is embedded onto a surface creating depressions on the surface. Embossing is when a pattern is embedded onto a surface creating a pattern that's raised above the surface. In some embodiments, embossing can be performed by pressing and indenting a pattern from the opposite surface of interest. Debossing versus embossing processes are commonly distinguished in the manufacturing of paper, cardstock, metal, fabric, plastic cards (such as loyalty cards, membership cards, bank cards), leather goods, and food. However, in other manufacturing sectors, particularly in North America, such as films, foam sheets, floor tiles, flooring underlayments, etc., the term “embossing” is commonly used to describe both debossing and embossing processes. In the method disclosed herein, patterns imparted onto extruded unfoamed or foamable sheets are via debossing. However, for consistency with the terminology used by commercial manufacturers of film and foam sheets, distributors of film and foam sheets, the manufacturers of articles containing film and foam sheets, and those of ordinary skill in the art for methods of manufacturing foams, the present disclosure uses the terms “embossing”, “embossed”, and “unembossed” (etc.) rather than “debossing”, “debossed”, and “undebossed” (etc.).

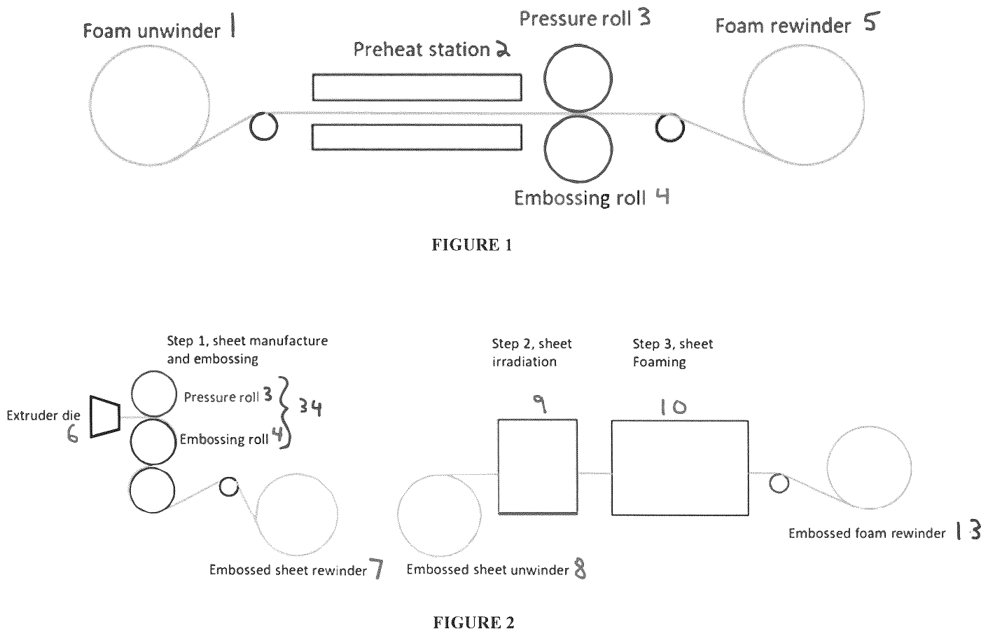

As stated above, one embossing process for crosslinked polyolefin foams includes: (a) extruding a foamable composition; (b) irradiating the foamable composition with ionizing radiation; (c) continuously foaming the composition; and then (d) embossing the foamed sheet. Such a traditional embossing processes is shown in FIG. 1 where a previously manufactured polyolefin foam roll is unwound from a foam unwinder 1, heated in a preheat station 2, sent through nip rollers 3, 4 under pressure or vacuum, wherein one of the nip rollers 4 has an engraved pattern to impart the engraved pattern onto the foam surface(s). The embossed foam sheet can then be rewound via a foam rewinder 5.

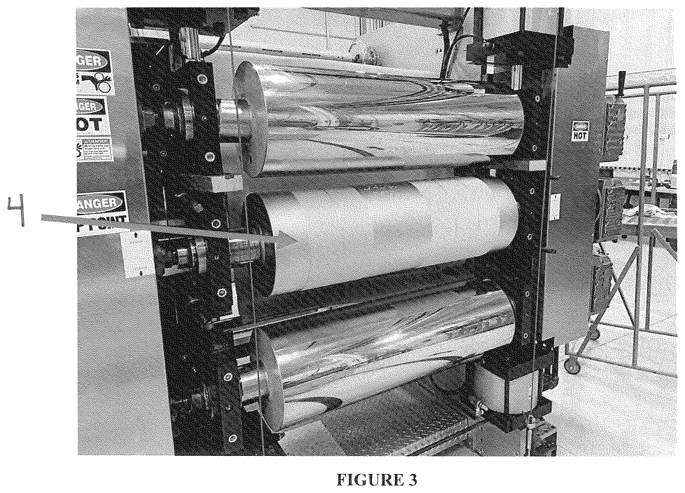

FIG. 2 illustrates an exemplary embossed foamed sheet production process in accordance with some embodiments disclosed herein. In contrast to the typical foam embossing process of FIG. 1, the embossing takes place during the extrusion step. Specifically, the extruder can deliver a steady amount of a foamable composition into an extruder die 6 to create an unfoamed or foamable sheet. The unfoamed extrudate can then be sent through an embossing nip 34. In some embodiments, the embossing nip can include a plurality of rollers 3, 4 (e.g., pressure rollers, hard rollers, embossing rollers, etc.). In some embodiments, the plurality of rollers can apply pressure to both sides of the extruded unfoamed sheet. In some embodiments, the embossing nip can include at least two rollers and, in some embodiments, the embossing nip can include at least three rollers. For example, FIG. 3 illustrates a three roll stack with embossing roll 4 in the middle pointed to by the arrow. As shown in FIG. 3, the middle embossing roll includes five embossing patterns and one embossing text pattern. In some embodiments, at least one of the rollers (e.g., embossing roller 4) can include at least one pattern on it. In some embodiments, more than one roller can include at least one pattern on a surface of the roller. In some embodiments, the pattern(s) can be engraved on the roller. In some embodiments, the pattern(s) can be any pattern to be created on at least one surface of the extruded unfoamed sheet. The patterns can come in a wide variety of shapes and sizes. For example, the pattern can be checkered pattern. In some embodiments, the pattern(s) can be a text pattern. During the embossing process, the at least one roller that includes the at least one pattern, can embed the at least one pattern into at least one surface of the extruded unfoamed sheet, thereby creating depressions in the at least one surface of the extruded unfoamed sheet. In some embodiments, the extruded unfoamed sheet can be sent through two rollers that include at least one pattern. In such embodiments, the rollers can embed the at least one patterns on both sides/surfaces of the extruded unfoamed sheet, thereby creating depressions in both surfaces of the extruded unfoamed sheet.

For embodiments where the extruded sheets were embossed on only one side, the thickness of the unfoamed embossed extruded sheet can be measured using a thickness gauge where the embossed side of the sheet can be placed on a flat level surface and contacted on the unembossed side by a spring loaded plunger incorporated with the gauge. A 3 mm hemispherical diameter tip can be attached to the plunger and contact the sheet at 26.5+/−3.5 gram-force.

In some embodiments, after the pattern can be embedded into at least one surface of the unfoamed or foamable sheet, the unfoamed sheet can be wound up via an embossed sheet rewinder 7. In some embodiments, the embossed sheet can be unwound via an embossed sheet unwinder 8 and fed into the irradiation unit 9. In some embodiments, the unfoamed sheet can be sent directly to the irradiation unit after embossing. In some embodiments, the irradiation unit can perform any of the irradiation techniques described herein.

There is a difference between “physical” crosslinking and “chemical” crosslinking. In chemical crosslinking, the crosslinks are generated with crosslinking promoters but without the use of ionizing radiation. Chemical crosslinking typically involves using peroxides, silanes, or vinylsilanes. In peroxide crosslinking processes, the crosslinking typically occurs in the extrusion die. For silane and vinylsilane crosslinking processes, the crosslinking typically occurs post-extrusion in a secondary operation where the crosslinking of the extruded material is accelerated with heat and moisture. Regardless of the chemical crosslinking method, chemically crosslinked foam sheets can typically exhibit primary surfaces that are significantly rougher than equivalent structures produced in the disclosed method. The surface profile of a foam sheet can be critical in many applications and thus chemically crosslinked foam sheets may not be used for certain applications. These applications can include a smooth foam surface to obtain desired properties such as improving the percentage contact area when a pressure sensitive adhesive (PSA) is applied onto the foam surface; ease of lamination to a film, fabric, fiber layer, and a leather; percentage contact area in the lamination; and/or visual aesthetics; etc. PCT Publication WO 2016109544 includes examples illustrating the difference in surface roughness between chemically crosslinked foamed polymer sheets and equivalent foamed polymer sheets produced by the disclosed method.

The rougher surfaces of chemically crosslinked foamed articles can be generally caused by larger sized cells (when compared to the foams produced according to the present disclosure). Although the cell size and size distribution may not matter in many commercial applications, because surface roughness is a function of cell size, foams with larger cells can be less desirable than foams with smaller cells for applications requiring a smooth foam surface.

Examples of ionizing radiation include, but are not limited to, alpha, beta (electron beams), x-ray, gamma, and neutron. Among them, an electron beam having uniform energy can be used to crosslink the embossed foamable sheet. Exposure time, frequency of irradiation (i.e., number of passes or number of exposures to radiation), and/or acceleration voltage upon irradiation with an electron beam can vary widely depending on the intended crosslinking degree and the thickness of the embossed unfoamed sheet. However, the ionizing radiation can generally be in the range of from about 10 to about 500 kGy, about 20 to about 300 kGy, or about 20 to about 200 kGy. If the exposure is too low, then crosslinking is too low such that cell stability may not be maintained upon foaming. If the exposure is too high, the irradiated sheet may curl and buckle excessively upon foaming making it difficult to produce a flat and uniform foam sheet. Also, a highly irradiated sheet may be highly crosslinked, where the crosslinking significantly reduces the ability of the polymer system to substantially elongate. Poor elongation of the polymer system may cause the sheet to tear and burst upon foaming in situations where the expansion of the foam exceeds the ultimate elongation property of the irradiated composition. Also, the unfoamed embossed sheet may be softened by exothermic heat release upon exposure to the electron beam radiation such that the structure can deform when the exposure is too high. In addition, the polymer components may also be degraded from excessive polymer chain scission.

The unfoamed sheet may be irradiated up to four separate times, no more than twice, or only once. If the irradiation frequency is more than about four times, the polymer components may suffer degradation so that upon foaming, for example, uniform cells will not be created in the resulting foam. When the thickness of the extruded sheet is greater than about 4 mm, irradiating each primary surface of the sheet with an ionized radiation can make the degree of crosslinking for the full depth of the sheet more uniform.

Irradiation with an electron beam provides an advantage in that extruded sheets having various thicknesses can be effectively crosslinked by controlling the acceleration voltage of the electrons. The acceleration voltage can generally be in the range of from about 200 to about 1500 kV, about 300 to about 1200 kV, or about 400 to about 1000 kV. If the acceleration voltage is less than about 200 kV, then the radiation may not reach the inner portion of the extruded embossed sheet. As a result, the cells in the inner portion can be coarse and uneven on foaming. Additionally, acceleration voltage that is too low for a given thickness profile can cause arcing, resulting in “pinholes” or “tunnels” in the embossed foamed structure. On the other hand, if the acceleration voltage is greater than about 1500 kV, then the polymers may degrade from exposure to excessive radiation.

Regardless of the type of ionizing radiation selected, crosslinking is performed so that the composition of the extruded structure is crosslinked to about 20% to about 75%, about 25% to about 60%, or about 30% to about 50% as measured by the “Toray Gel Fraction Percentage Method.” According to the “Toray Gel Fraction Percentage Method,” tetralin solvent is used to dissolve non-crosslinked components in a composition. In principle, the non-crosslinked material is dissolved in tetralin and the crosslinking degree is expressed as the weight percentage of crosslinked material in the entire composition. The apparatus used to determine the percent of polymer crosslinking includes: 100 mesh (0.0045 inch wire diameter) Type 304 stainless steel bags; numbered wires and clips; a Miyamoto thermostatic oil bath apparatus; an analytical balance; a fume hood; a gas burner; a high temperature oven; an anti-static gun; and three 3.5 liter wide mouth stainless steel containers with lids. Reagents and materials used include tetralin high molecular weight solvent, acetone, and silicone oil. Specifically, an empty wire mesh bag is weighed and the weight recorded. For each sample, 100 milligrams±5 milligrams of sample is weighed out and transferred to the wire mesh bag. The weight of the wire mesh bag and the sample, typically in the form of thinly sliced foam cuttings, is recorded. Each bag is attached to the corresponding number wire and clips. When the solvent temperature reaches 130° C., the bundle (bag and sample) is immersed in the solvent. The samples are shaken up and down about 5 or 6 times to loosen any air bubbles and fully wet the samples. The samples are attached to an agitator and agitated for three (3) hours so that the solvent can dissolve the foam. The samples are then cooled in a fume hood. The samples are washed by shaking up and down about 7 or 8 times in a container of primary acetone. The samples are washed a second time in a second acetone wash. The washed samples are washed once more in a third container of fresh acetone as above. The samples are then hung in a fume hood to evaporate the acetone for about 1 to about 5 minutes. The samples are then dried in a drying oven for about 1 hour at 120° C. The samples are cooled for a minimum of about 15 minutes. The wire mesh bag is weighed on an analytical balance and the weight is recorded. Crosslinking is then calculated using the formula 100*(C−A)/(B−A), where A=empty wire mesh bag weight; B=wire bag weight+foam sample before immersion in tetralin; and C=wire bag weight+dissolved sample after immersion in tetralin.

A crosslinking promoter can optionally be used to reduce the exposure of the foamable embossed sheet to ionizing radiation to obtain a desired gel. Suitable crosslinking promoters include, but are not limited to, commercially available difunctional, trifunctional, tetrafunctional, pentafunctional, and higher functionality monomers. Such crosslinking monomers are available in liquid, solid, pellet, and powder forms. Examples include, but are not limited to, acrylates or methacrylates such as 1,6-hexanediol diacrylate, 1,6-hexanediol dimethacrylate, ethylene glycol diacrylate, ethylene glycol dimethacrylate, trimethylol propane trimethacrylate, tetramethylol methane triacrylate, 1,9-nonanediol dimethacrylate and 1,10-decanediol dimethacrylate; allyl esters of carboxylic acid (such as trimellitic acid triallyl ester, pyromellitic acid triallyl ester, and oxalic acid diallyl ester); allyl esters of cyanulic acid or isocyanulic acid such as triallyl cyanurate and triallyl isocyanurate; maleimide compounds such as N-phenyl maleimide and N,N′-m-phenylene bismaleimide; compounds having at least two tribonds such as phthalic acid dipropagyl and maleic acid dipropagyl; and divinylbenzene. Additionally, such crosslinking promoters may be used alone or in any combination.

Crosslinking promoters can vary in crosslinking efficiency based on the ionizing radiation dosage, the polymers being crosslinked, the chemical structure of the monomer, the number of functional groups on the monomer, and/or whether the monomer is a liquid or a powder.

Crosslinks may be generated using a variety of different techniques and can be formed both intermolecularly, between different polymer molecules, and intramolecularly, between portions of a single polymer molecule. Such techniques include, but are not limited to, (a) exposing the polymer molecules to ionizing radiation, (b) providing crosslinking promoters which are separate from a polymer chain and exposing the crosslinking promoters and polymers to ionizing radiation, and/or (c) providing polymer chains which incorporate a crosslinking promoter as a functional group which can form a crosslink or be activated to form a crosslink.

After irradiating the extruded embossed sheet, foaming may be accomplished by a foaming unit 10. In some embodiments, the irradiated sheet can be sent directly to the foaming unit after irradiating. In some embodiments, the irradiated sheet can be wound up after irradiation and, at a later time, the wound irradiated sheet can be unwound and fed to the foaming unit for foaming. In some embodiments, the foaming unit can perform any of the foaming techniques described herein.

In some embodiments, foaming may be accomplished by heating the crosslinked sheet to a temperature higher than the decomposition temperature of the thermally decomposable blowing agent. In some embodiments, the foaming can be performed at about 200-260° C. or about 220-240° C. in a continuous process. In some embodiments, continuous foaming process can be preferred over a batch process for production of a continuous foamed sheet.

The foaming can be typically conducted by heating the crosslinked embossed sheet with molten salt, radiant heaters, vertical or horizontal hot air oven, microwave energy, or a combination of these methods. The foaming may also be conducted in an impregnation process using, for example, nitrogen in an autoclave, followed by a free foaming via molten salt, radiant heaters, vertical or horizontal hot air oven, microwave energy, or a combination of these methods. Optionally, before foaming, the crosslinked sheet can be softened with preheating. This can help stabilize the expansion of the structure upon foaming, particularly with thick and stiff sheets.

The density of the embossed foam sheet can be defined and measured using section or “overall” density, rather than a “core” density, as measured by JIS K6767. The foam sheets produced using the above-described method can yield foams with a section, or “overall” density of about 15-200 kg/m³, about 25-150 kg/m³, or about 30-125 kg/m³. In some embodiments, the section density can be controlled by the amount of blowing agent and the thickness of the extruded sheet. If the density of the foam sheet is less than about 15 kg/m³, then the sheet may not foam efficiently due to a large amount of chemical blowing agent to attain the density. Additionally, if the density of the sheet is less than about 15 kg/m³, then the expansion of the sheet during the foaming step may become increasingly difficult to control. Furthermore, if the density of the foam sheet is less than about 15 kg/m³, then the foam may become increasingly prone to cell collapse. Thus, it may be difficult to produce a foam sheet of uniform section density and thickness at a density less than about 15 kg/m³.

The foam sheet is not limited to a section density of about 200 kg/m³. A foam having a section density of about 300 kg/m³, about 400 kg/m³, or about 500 kg/m³ may also be produced. However, the foam sheet may have a density of less than about 200 kg/m³ since greater densities can be generally cost prohibitive when compared to other materials which can be used in a given application.

In some embodiments, the foam produced using the above method may have closed cells. In some embodiments, at least 90% of the cells have undamaged cell walls, at least 95%, or more than 98% when measured using a pycnometer according to ASTM D6226 or ISO 4590.

In some embodiments, the average cell size can be from about 0.05 to about 1.0 mm, or from about 0.1 to about 0.7 mm when measured according to ASTM D3576. If the average cell size is less than about 0.05 mm, then the density of the foam structure can typically be greater than 200 kg/m³. If the average cell size is larger than 1 mm, the foam may have an uneven surface. There is also a possibility of the foam being undesirably torn if the population of cells in the foam does not have the preferred average cell size. This can occur when the foam is stretched, when a shear force is applied to the foam, and/or when portions of it are subjected to a secondary process. In some embodiments, the cell size in the foam may have a bimodal distribution representing a population of cells in the core of the foam which are relatively round and a population of cells in the skin near the surfaces of the foam structure which are relatively flat, thin, and/or oblong.

The overall thickness of the foamed embossed sheet is measured according to JIS K6767 and can be about 0.5 mm to about 50 mm, about 0.6 mm to about 40 mm, about 0.7 mm to about 30 mm, or about 0.8 mm to about 20 mm. If the thickness is less than about 0.5 mm, then foaming may not be efficient due to significant gas loss from the primary surface(s). If the thickness is greater than about 50 mm, expansion during the foaming step can become increasingly difficult to control. Thus, it can be increasingly more difficult to produce a embossed foam sheet with uniform section density and thickness.

In some embodiments, the desired foam thickness can be obtained by a secondary process such as slicing, skiving, or bonding. Slicing, skiving, or bonding can produce a thickness range of about 0.2 mm to about 100 mm.

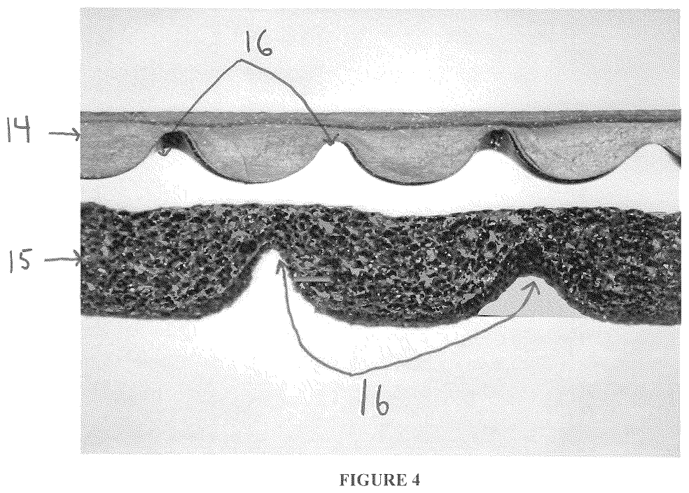

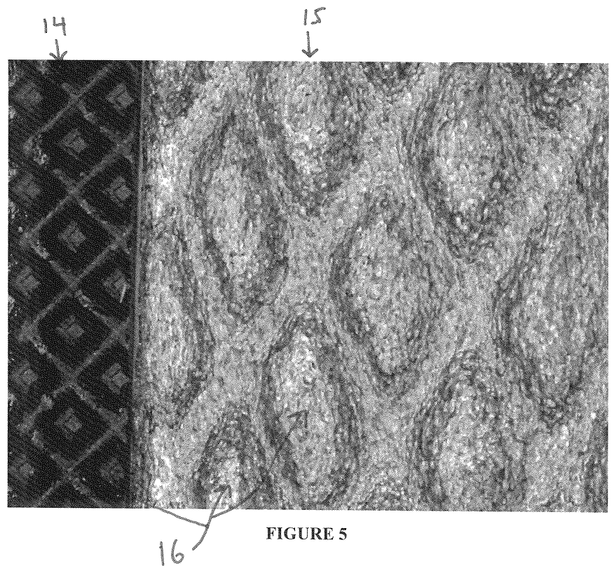

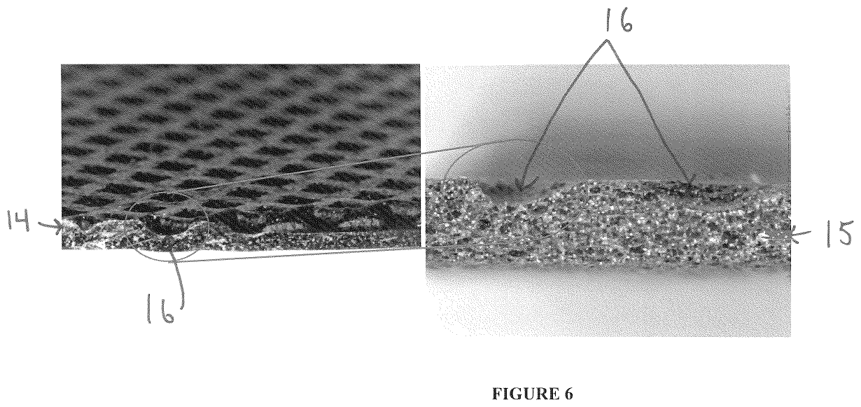

FIG. 6 illustrates a cross section of an unfoamed embossed sheet 14 and a close-up view of a cross section of a foamed embossed sheet 15 that has pattern 16 embedded in a surface of the embossed foam sheet. As seen in FIG. 6, the other side of the foam sheet is not embossed. In some embodiments, the foamed embossed sheet may not retain the embedded pattern of the unfoamed embossed sheet. In some embodiments, expansion of the embossed sheet in the foaming step for the machine direction (MD), cross-machine direction/transverse direction (abbreviated XMD or CMD or CD or TD), and thickness direction (ZD) can change the dimensions of the embossed pattern. For example, the embossed pattern 16 on a surface shown in a cross section of the unfoamed embossed sheet 14 in FIG. 4 and the top view of unfoamed embossed sheet 14 in FIG. 5 are different from the corresponding embossed pattern 16 shown in cross section of the foamed embossed same sheet 15 in FIG. 4 and the top view of the foamed embossed same sheet 15 in FIG. 5.

Variables effecting the expansion in each primary direction include, but are not limited to, the chemical blowing agent amount and type(s), the type(s) and quantities of polypropylene and polyethylene in the extruded composition, the thickness of the unfoamed embossed sheet, the crosslinked percentage of the unfoamed embossed sheet, the embossed pattern, the foaming temperature, the residence time of the sheet within the heating equipment, and/or the tension imparted on the sheet by both the foaming equipment and gravity, etc. Thus, to obtain a desired pattern on the embossed foam, the engraved pattern on the embossing roll may be selected to account for the expansion of the irradiated embossed sheet in the three primary directions in the foaming step.

In some embodiments, after foaming, the foamed embossed sheet can be wound via an embossed foam rewinder 13.

The embossed foams or foamed sheets can be used in a variety of applications. Some embodiments include a first layer of the embossed foam and a second layer selected from the group consisting of a solid hardwood floor panel, an engineered wood floor panel, a laminate floor panel, a vinyl floor tile, a ceramic floor tile, a porcelain floor tile, a stone floor tile, a quartz floor tile, a cement floor tile, and/or a concrete floor tile.

In some embodiments, the unembossed side of the first layer may be joined to the adjacent panel or tile by means of chemical bonds, mechanical means, or a combination thereof. The adjacent laminate layers may also be affixed to each other by any other means including the use of attractive forces between materials having opposite electromagnetic charges or attractive forces present between materials which both have either a predominantly hydrophobic character or a predominantly hydrophilic character.

In some embodiments, attaching an embossed foam or foamed sheet disclosed herein to a floor panel—particularly a solid hardwood floor panel, an engineered wood floor panel, and/or a laminate floor panel—can be via a pressure sensitive adhesive layer that can be disposed on at least a portion of the foam surface and/or panel surface. Any pressure sensitive adhesive known in the art may be used. Examples of such pressure sensitive adhesives include, but are not limited to, acrylic polymers, polyurethanes, thermoplastic elastomers, block copolymers, polyolefins, silicones, rubber based adhesives, copolymers of ethylhexylacrylate and acrylic acid, copolymers of isooctyl acrylate and acrylic acid, blends of acrylic adhesives and rubber based adhesives as well as combinations of the foregoing. The embossed foam attached to the floor panel—particularly a solid hardwood floor panel, an engineered wood floor panel, and a laminate floor panel—can serve several purposes. The foam can reduce the reflected sound pressure level when the panel is impacted, for example, when walking on the panel with boots or high heeled shoes. The foam can also act as a moisture vapor barrier between the panel and sub-floor and can help provide a more uniform laydown among multiple panels since any unevenness, bumps, or spikes (for example a protruding nailhead) on the sub-floor will be buffered by the foam. These floor panels and tiles can be installed in residential homes, office buildings, and/or other commercial buildings.

In some embodiments, a flooring system is provided that includes: a top floor layer; a sub-floor layer; and one or more underlayment layers where at least one of the underlayment layers includes the disclosed embossed foam or foam sheet disposed between the sub-floor and the top floor layer. In this system, the embossed foam layer may or may not be joined to any adjacent layer, including the sub-floor or the top floor layer. In some embodiments, the attachment can be performed by means of chemical bonds, mechanical means, or combinations thereof. The adjacent layers may also be affixed to each other by any other means including the use of attractive forces between materials having opposite electromagnetic charges or attractive forces present between materials which both have either a predominantly hydrophobic character or a predominantly hydrophilic character. In some embodiments, attachment can be by the use of either a one component urethane adhesive, a two component urethane adhesive, a one component acrylic adhesive, and/or a two component acrylic adhesive. The adhesive can be applied during the installation of the system in residential homes, office buildings, and/or commercial buildings. The embossed foam in this system can serve several purposes. The foam can reduce the reflected sound pressure level when the top floor layer is impacted, for example, when walking on the panel with boots or high heeled shoes. The foam can also act as a moisture vapor barrier between the panel and sub-floor and help provide a more uniform laydown among multiple panels since any unevenness, bumps, or spikes (for example a protruding nailhead) on the sub-floor can be buffered by the foam. For cases where the top floor layer is composed of ceramic floor tiles, porcelain floor tiles, stone floor tiles, quartz floor tiles, cement floor tiles, and/or concrete floor tiles connected by grout and where all layers in the flooring system are joined, the foam can help reduce grout fracturing by buffering varying thermal expansions and contractions of the various layers in the system.

To satisfy the requirements of any of the above applications, the disclosed embossed foam structures may be subjected to various secondary processes, including and not limited to, corona or plasma treatment, additional embossing, surface roughening, surface smoothing, perforation or microperforation, splicing, slicing, skiving, layering, bonding, and hole punching.

This application discloses several numerical ranges in the text. The numerical ranges disclosed inherently support any range or value within the disclosed numerical ranges, including the endpoints, even though a precise range limitation is not stated verbatim in the specification because this disclosure can be practiced throughout the disclosed numerical ranges.

The above description is presented to enable a person skilled in the art to make and use the disclosure, and is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown, but is to be accorded the widest scope consistent with the principles and features disclosed herein. Finally, the entire disclosure of the patents and publications referred in this application are hereby incorporated herein by reference.

What is claimed is:

1. A method of forming an embossed polyolefin foam comprising:
extruding a foamable sheet comprising polypropylene and/or polyethylene;
embedding a pattern on at least one side of the extruded foamable sheet;
irradiating the embedded foamable sheet with ionizing radiation; and
foaming the irradiated foamable sheet.

2. The method of claim 1, wherein embedding the pattern on the at least one side of the extruded foamable sheet comprises applying pressure to both sides of the extruded foamable sheet via a plurality of rollers.

3. The method of claim 2, wherein the plurality of rollers comprises at least one roller comprising the pattern.

4. The method of claim 3, wherein the pattern is engraved on the at least one roller.

5. The method of claim 1, further comprising embedding a second pattern on a side of the extruded foamable sheet opposite the side of the extruded foamable sheet with the embedded first pattern.

6. The method of claim 1, wherein the pattern comprises depressions in the at least one side of the extruded foamable sheet.

7. The method of claim 1, wherein the pattern comprises a text pattern.

8. The method of claim 1, wherein the embedded pattern comprises depressions on the at least one side of the extruded foamable sheet and the depressions are 5-75% of an overall thickness of the embedded foamable sheet.

9. The method of claim 1, wherein the foamable sheet comprises a chemical foaming agent.

10. The method of claim 1, wherein the ionizing radiation is selected from the group consisting of alpha, beta (electron), x-ray, gamma, and neutron.

11. The method of claim 1, wherein the embedded foamable sheet is irradiated up to four separate times.

12. The method of claim 1, wherein the ionizing radiation crosslinks the embedded foamable sheet to a crosslinking degree of 20-75%.

13. The method of claim 1, wherein foaming comprises heating the irradiated foamable sheet with molten salt and radiant heaters or a hot air oven.

14. The method of claim 1, further comprising applying a laminate layer to a side of the foamed sheet opposite the side of the foamed sheet with the embedded pattern.

15. The method of claim 14, wherein the laminate layer comprises a solid hardwood floor panel, an engineered wood floor panel, a laminate floor panel, a vinyl floor tile, a ceramic floor tile, a porcelain floor tile, a stone floor tile, a quartz floor tile, a cement floor tile, or a concrete floor tile.

16. The method of claim 14, further comprising applying a pressure sensitive adhesive layer to a side of the foamed sheet opposite the side of the foamed sheet with the embedded first pattern prior to applying the laminate layer to the side of the foamed sheet opposite the side of the foamed sheet with the embedded pattern.

17. The method of claim 14, further comprising applying a pressure sensitive adhesive layer to a side of the laminate layer prior to applying the laminate layer to the side of the foamed sheet opposite the side of the foamed sheet with the embedded pattern.

18. A flooring system comprising:
a top floor layer;
an underlayment layer comprising the embossed polyolefin foam of claim 1, wherein the one or more underlayment layers are on a side of the top floor layer; and
a sub-floor layer on a side of the underlayment layer opposite the top floor layer.

19. The flooring system of claim 18, wherein the top floor layer is attached to the underlayment layer and the sub-floor layer is attached to the underlayment layer via an adhesive.

20. The flooring system of claim 19, wherein the adhesive comprises a urethane adhesive and/or an acrylic adhesive.
